(19) United States
(12) Patent Application Publication
(10) Pub. No.: US 2003/0154095 A1
(43) Pub. Date: Aug. 14, 2003

(54) Computer system for automatically optimizing a vehicle specification

(76) Inventors: Keiji Takakura, Tokyo (JP); Michitada Kameoka, Wako-shi (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/345,395

(22) Filed: Jan. 16, 2003

(30) Foreign Application Priority Data
Feb. 14, 2002 (JP) 2002-036724

(51) Int. Cl. G06F 17/60

(52) U.S. Cl. 705/1; 705/26

(57) ABSTRACT

A computer system for optimizing a specification of a vehicle to meet the needs of customers is provided. The system comprises a customer database for storing one or more factors associated with the needs of customers for the vehicle and a specification optimizing engine. The specification optimizing engine analyzes the factors in the customer database to determine whether the vehicle meets the needs of customers. The specification optimizing engine extracts the needs of customers from the customer database if it is determined that the vehicle does not meet the needs of customers and determines a specification optimized to meet the extracted needs of customers. The needs of customers may include a desired specification item that customers desire for the vehicle and an undesired specification item that customers do not desire. The determined specification may be adjusted to meet the requirement of a vehicle supplier. Thus, the optimized specification of the vehicle is automatically generated.

### BACKGROUND OF THE INVENTION

The present invention relates to a computer system for automatically optimizing a vehicle specification to meet the needs of customers.

Several computer-based methods for providing products in accordance with the needs of customers are proposed. The Japanese Patent Application Unexamined Publication No. 2000-132591 discloses a system for customizing product information in accordance with specified rules to offer products adapted to particular companies.

According to another method disclosed in the Japanese Patent Application Unexamined Publication No. 2001-306783, a plurality of product concepts are collected through questionnaires. For each of the collected product concepts, the number of sample persons who recognize that the product concept is a concept of an ideal product and the number of sample persons who recognize that the product concept is a concept of the existing product are determined. A product concept having a relatively large ratio of “the former number/the latter number” is a target of development.

When a vehicle is developed for sales, the needs of customers are of course taken into consideration. A vehicle specification is designed so as to meet the needs of customers. The needs of customers are usually determined by analysis performed by experts based on the actual sales of vehicles in the past, questionnaires to customers, market researches and so on. The vehicle specification is determined so that the determined needs of customers are balanced with requirements of the company involved in development and manufacturing of the vehicle.

The needs of customers vary depending on the trend of the times, economic conditions and so on. The needs at a time when a vehicle is sold are often different from the needs after several years since the selling of the vehicle. A vehicle specification determined based on an analysis such as market research may not timely reflect the current needs of customers because such an analysis is a time-consuming job.

A vehicle specification includes various components such as engine performance, interior design, body design, equipment of an audio system and so on. There are enormous combinations of such components. According to a conventional method, it is difficult to determine, from such enormous combinations, the specification that meets customers' diversified needs and company requirements.

Thus, there exists a need for a system and method that can timely determine a specification optimized to meet the current needs of customers. There exists another need for a system and method that can automatically select a combination of components to meet the needs of customers from a large number of combinations of components mountable on a vehicle.

### SUMMARY OF THE INVENTION

According to one aspect of the invention, a computer system optimizes a vehicle specification that meets the needs of customers. The system comprises a customer database for storing one or more factors associated with the needs of customers for the vehicle. The system further comprises a specification optimizing engine. The specification optimizing engine is programmed to analyze the factors in the customer database to determine whether the vehicle meets the needs of customers. If it is determined that the vehicle does not meet the needs of customers, the needs of customers are extracted from the customer database. A vehicle specification that meets the extracted needs of customers is determined.

According to the invention, a vehicle that has a specification adapted to the needs of customers is timely provided based on the analysis of the factors associated with the needs of customers.

According to one embodiment of the invention, the specification optimizing engine is further programmed to adjust the optimized specification to meet the requirement of a vehicle supplier. Because a specification finally generated meets the company requirement, a system for manufacturing the vehicle is immediately arranged.

According to one embodiment of the invention, the factors include a score indicating the degree of customer satisfaction for the vehicle. The specification optimizing engine determines that the vehicle does not meet the needs of customers if the score decreases. According to another embodiment of the invention, the factors include a sales volume or an order volume of the vehicle. The specification optimizing engine determines that the vehicle does not meet the needs of customers if the sales volume or the order volume decreases.

According to yet another embodiment of the invention, the factors includes sales performance in the vehicle industry and a sales volume of the vehicle. The specification optimizing engine determines that the vehicle does not meet the needs of customers if the sales volume of the vehicle decreases compared with the sales performance in the vehicle industry. In any of the above-described embodiments of the invention, the analysis of the factors makes it possible to determine whether the vehicle meets the needs of customers. Furthermore, since a process for generating the specification is automatically activated in response to the determination that the vehicle does not meet the needs of customers, a specification that meets the needs of customers is timely generated.

According to one embodiment of the invention, generation of the optimized specification includes comparing a current specification of the vehicle with a specification of a vehicle of another company. A specification item of the current specification that is evaluated to be inferior to the specification of the vehicle of the other company is extracted. The current specification is modified for the extracted specification item. The modification of the current specification is performed so that the extracted specification item is comparable to the specification of the vehicle of the other company. Thus, a specification item inferior to a competitive vehicle is improved to automatically generate a specification comparable to the competitive vehicles.

According to one embodiment of the invention, the needs of customers include a desired specification item that customers desire for a current specification of the vehicle and an undesired specification item that customers do not desire. Generation of the optimized specification includes adding the desired specification item to the current specification of the vehicle and deleting the undesired specification item from the current specification. Thus, a specification that meets the needs of customers is automatically generated.

According to one embodiment of the invention, the current specification of the vehicle includes a set of exclusive components. Each component included in the set of the exclusive components is neither added nor deleted independently. If the desired specification item is included in the set of the exclusive components, the addition of the desired specification item to the current specification is canceled. If the undesired specification item is included in the set of the exclusive components, the deletion of the undesired specification item from the current specification is canceled. Since optimization of the specification is performed in view of the exclusive components, generation of impractical specification is avoided.

According to one embodiment of the invention, the company requirement includes an upper limit of the number of manufacturing steps for production of the vehicle. According to another embodiment of the invention, the company requirement includes an upper limit of the number of combinations of specification items included in a specification of the vehicle. The optimized specification is adjusted to meet the company requirements. Thus, the optimized specification finally generated is a specification that can be immediately used by the company for the vehicle production.

### BRIEF DESCRIPTION OF THE DRAWINGS

FIG. 1 is a general block diagram showing a system in accordance with one embodiment of the invention.

FIG. 2 is a detailed functional block diagram of a specification optimizing engine in accordance with one embodiment of the invention.

FIG. 3 is an example of a customer database in accordance with one embodiment of the invention.

FIG. 4 is an example of a sales database in accordance with one embodiment of the invention.

FIG. 5 is an example of an industry database in accordance with one embodiment of the invention.

FIG. 6 is an example of an other-companies database in accordance with one embodiment of the invention.

FIG. 7 is an example of a company database in accordance with one embodiment of the invention.

FIG. 8 is a flowchart showing a main routine of an optimization process in accordance with one embodiment of the invention.

FIG. 9 is a flowchart showing a trigger detection routine in accordance with one embodiment of the invention.

FIG. 10 is a flowchart showing a trigger detection routine in accordance with one embodiment of the invention.

FIG. 11 is a flowchart showing an optimization routine in accordance with one embodiment of the invention.

FIG. 12 is a flowchart showing an optimization routine in accordance with one embodiment of the invention.

FIG. 13 is a flowchart showing an optimization routine in accordance with one embodiment of the invention.

FIG. 14 is a flowchart showing an optimization routine in accordance with one embodiment of the invention.

### DESCRIPTION OF THE PREFERRED EMBODIMENTS

Referring to the attached drawings, specific embodiments of the invention will be described. In the following description, vehicles Y and Z generally indicate vehicles belonging to a certain vehicle type, but do not indicate one specific vehicle.

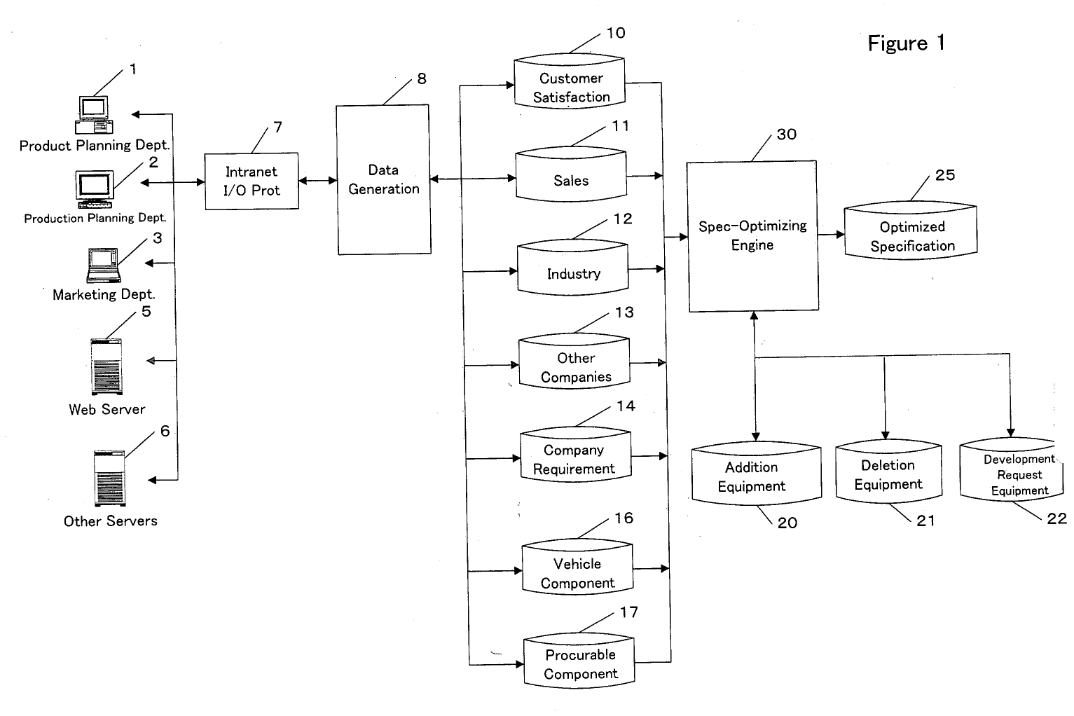

FIG. 1 is a general block diagram showing a system in accordance with one embodiment of the present invention. A marketing support computer system of a company X that manufactures and sells vehicles is shown. Terminals 1 to 3, which can be personal computers, in a product planning department, a production planning department and a marketing department are connected to an intranet input/output 7 of the marketing support computer system through an intranet of the company X.

A web server 5 that maintains a website of the company X is also connected to the intranet input/output 7 of the company X. The website of the company X prepares a page for providing customers with a questionnaire about vehicles sold by the company X. A customer can fill in the questionnaire on the page and transmit it. Alternatively, a customer may answer the questionnaire by e-mail.

Other servers 6 that may be installed at sales offices and/or dealers are also connected to the intranet input/output 7. A questionnaire is prepared on paper at sales offices, dealers and/or exhibitions etc. Data that a customer filled in the questionnaire is entered into the marketing support system through the terminal 3 and the servers 6.

The data transferred through the terminals 1 through 3 and the servers 5 and 6 is delivered to a data generation part 8 via the intranet input/output 7. The data generation part 8 uses the data to generate data to be stored in databases 10 through 17. The generation part 8 also uses the data to update the databases 10 through 17.

A customer satisfaction (CS) database 10 stores customer satisfaction regarding a vehicle sold by the company. The customer satisfaction is converted into a numerical value based on customers' answers to questionnaires. Furthermore, the customer satisfaction database 10 includes detailed data for equipment that customers desire and equipment that customers do not desire, which are also generated based on customers' answers to questionnaires. The desired/undesired equipment data represents the needs of customers. The desired/undesired equipment data is associated with the customer satisfaction.

A sales database 11 stores monthly sales volume and monthly order volume of vehicles supplied by the company. An industry database 12 stores monthly sales volume of vehicles belonging to each category in the vehicle industry. The category is predefined according to a factor such as engine displacement. Vehicles in the vehicle industry are classified according to the category.

An other-companies database 13 stores information about vehicles newly released by other companies. Specifically, the other-companies database 13 stores information about the time when vehicles are released by other companies and the types of the vehicles. The other-companies database 13 may store information including a category, engine displacement, equipment, price, sales volume and/or order volume.

A company requirement database 14 stores requirements for development and production of a vehicle to be considered by the company. Usually, there exist various requirements in the company X so as to generate profits from sales of vehicles and to actually manufacture vehicles. These requirements include, for example, a form of a production line, the rate of operation of a production line, the number of manufacturing steps, the number of components, and the number of combinations of the components. Each of the company requirements is associated with a vehicle type and vehicle grade to which the requirement is applied.

The company requirement database 14 further stores information about exclusive components of a vehicle. A set of the exclusive components indicates a combination of components that need to be mounted together on the vehicle. For example, a “sunroof” is an exclusive component which needs to be mounted together with a “power steering.” When a customer requests a “sunroof”, a “power steering” needs to be installed together. A “power steering” is also an exclusive component that needs to be installed together with a “sunroof.” A “sunroof” and a “power steering” constitute one set of exclusive components. Each exclusive component is associated with a vehicle type and vehicle grade.

A vehicle component database 16 stores information related to components with which vehicles are equipped. In the embodiment, each of “components with which vehicles are equipped” means a component that is specified as one item in a vehicle specification. Therefore, it will be hereinafter referred to as a specification item. The vehicle component database 16 further stores information about suppliers, the number of lots, and costs etc. for each of the specification items. Each component is associated with a vehicle type and vehicle grade on which the component is mountable.

A procurable component database 17 stores a list of specification items (components) procurable from the company X and/or related suppliers. The procurable component database 17 may further store, for each of the specification items, information about suppliers, cost, the availability of stock, and/or vehicles on which the specification item is currently mounted. For each of the specification items, the procurable component database 17 may store an indication indicating whether addition and deletion of the specification item are allowable in a minor change or in a full model change for the vehicle.

A specification optimizing engine 30 optimizes a vehicle specification to meet the needs of customers for a vehicle sold by the company X based on data stored in the databases 10 through 17. The optimized specification is stored in an optimized specification database 25.

When an optimized specification for the vehicle Y is generated by the specification optimizing engine 30, a difference between the optimized specification and the current specification of the vehicle Y is stored in databases 20 through 22. The optimized specification may include specification items that are not included in the current specification. If such specification items are not procurable in the company X, the specification items need to be newly developed. Therefore, the specification items are stored in a development request equipment database 22. On the other hand, if such specification items are procurable in the company X, the specification items are stored in an addition equipment database 20. The current specification may include specification items that are not included in the optimized specification. Such specification items are stored in a deletion equipment database 21.

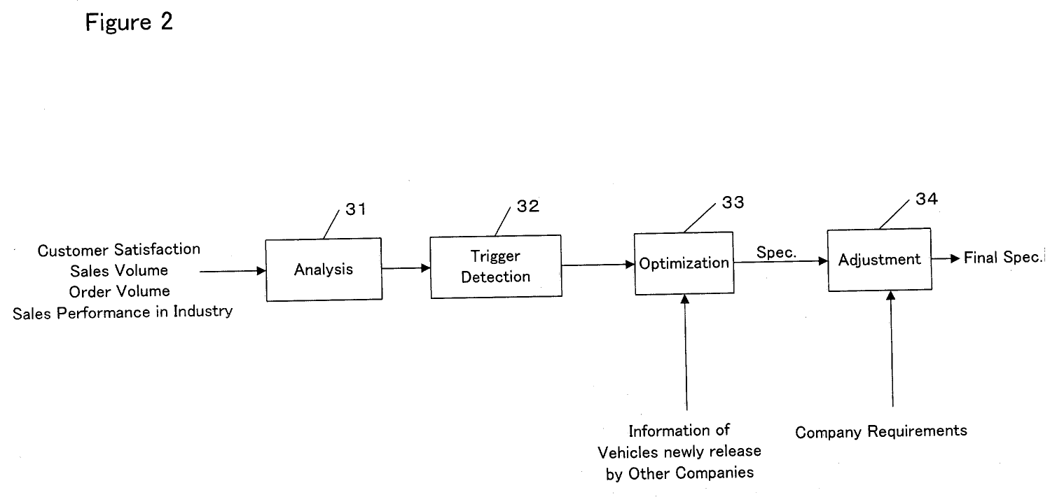

FIG. 2 is a functional block diagram of the specification optimizing engine 30 shown in FIG. 1. As described below, an analysis part 31 analyzes factors including customer satisfaction, a sales volume and an order volume of the vehicle Y, and sales performance in the vehicle industry, each of which is extracted from the databases 10 through 12, respectively.

(1) Customer satisfaction: It is determined whether the customer satisfaction has decreased. Alternatively, it may be determined that the customer satisfaction does not reach a predetermined level, or that the customer satisfaction has decreased by a predetermined value or more.

(2) Sales volume: It is determined whether the sales volume of the vehicle Y has decreased compared with the vehicle industry's sales volume in the category to which the vehicle Y belongs. Alternatively, it may be determined that the sales volume of the vehicle Y has not reached a predetermined level relative to the vehicle industry's sales volume.

(3) Order volume: It is determined whether the order volume of the vehicle Y has decreased. Alternatively, it may be determined that the order volume of the vehicle Y has not reached a predetermined level, or that the order volume has decreased by a predetermined amount or more.

As shown in the above (1) through (3), when any of the customer satisfaction, the sales volume and the order volume has decreased, it indicates that the vehicle Y does not meet the needs of customers for some reason. A trigger detection part 32 activates an optimization process if any of the customer satisfaction, the sales volume and the order volume has decreased.

Alternatively, other factors that reflect variations in the needs of customers may be used to perform the analysis in addition to the above factors, or instead of the above factors. For example, the analysis may be performed in view of economic conditions.

An optimization part 33 performs either a first or second optimization process depending on information about vehicles newly released by other companies. When a vehicle Z belonging to the same category as the vehicle Y is released from another company within a predetermined time period, the first optimization process is performed. When no vehicle belonging to the same category as the vehicle Y is released from any other companies within the predetermined time period, the second optimization process is performed.

The first optimization process compares the specification of the vehicle Y with a specification of the vehicle Z of the other company. A specification item of the vehicle Y that is evaluated to be inferior to the specification of the vehicle Z of the other company is extracted. In order to cause the extracted specification item to reach the specification level of the vehicle Z, the first optimization process determines specification items that are to be added to and deleted from the current specification of the vehicle Y. When the specification items to be added are not procurable in the company X, the specification items are determined as specification items that are to be developed.

The second optimization process modifies the current specification based on desired equipment data and undesired equipment data that are associated with the customer satisfaction. If specification items for the equipment that customers desire are not procurable, the specification items are determined as specification items that are to be developed. If specification items for the equipment that customers desire are procurable, the specification items are determined as specification items that are to be added. Specification items for the equipment that customers do not desire are determined as specification items that are to be deleted.

The first and second optimization processes add to the current specification the specification items determined to be added, and delete from the current specification the specification items determined to be deleted so as to generate the optimized specification. The specification items determined to be developed are stored in the development request database 22 for future development.

Alternatively, in the first optimization process, vehicles of other companies to be compared with the vehicle Y may be more limited. For example, if another company releases a vehicle that has a body type (sedan, wagon etc.), price range or displacement class similar to the vehicle Y, the comparison between the released vehicle of the other company and the vehicle Y is performed. In another embodiment, vehicles of other companies to be compared with the vehicle Y may not be limited to vehicles newly released within the predetermined time period. For example, the comparison may be performed with all vehicles that are being sold by other companies and belong to the same category as the vehicle Y.

The optimization process may be performed for each vehicle type. Furthermore, the optimization process may be performed for each vehicle grade of a given vehicle type.

An adjustment part 34 adjusts the specification generated by the optimization part 33 to meet the company requirements specified in the company requirement database 14. In the embodiment, the company requirements include an upper limit of the number of manufacturing steps for production of the vehicle Y and an upper limit of the number of combinations of specification items for the vehicle Y. The specification generated by the optimization part 33 is adjusted not to exceed the upper limits of the number of manufacturing steps and the number of combinations thus defined. The specification is further adjusted to meet the requirements for the exclusive components.

Alternatively, other company-requirements may be included. For example, the number of specification items and cost requirement may be included.

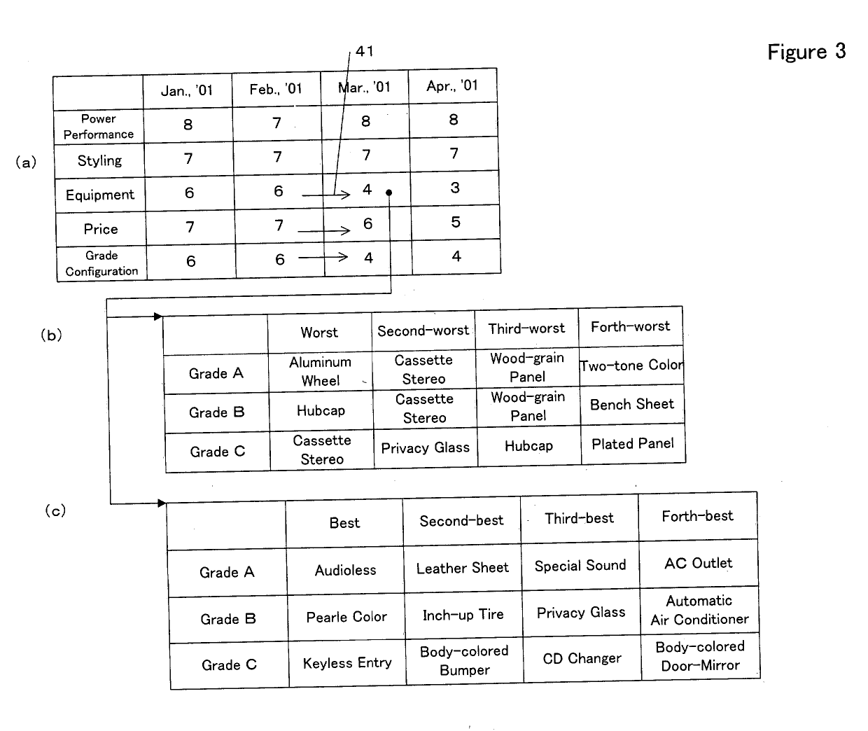

FIG. 3(a) shows an example of a customer satisfaction table included in the customer satisfaction database 10. In the customer satisfaction table, monthly customer satisfaction for each of power performance, styling, equipment, price, and grade configuration of the vehicle Y is converted into a numerical value based on customers' answers to questionnaires. Such a numerical value will be hereinafter referred to as a score. The larger the score is, the higher the customer satisfaction is.

As pointed out by an arrow 41 in FIG. 3(a), the score of the equipment decreases from 6 to 4 over February through March. Similarly, the scores of the price and the grade configuration decrease. As described above, these decreases may be a trigger for activating the optimization process. Alternatively, the optimization process may be activated when the score is equal to or less than a predetermined value (for example, 4).

FIGS. 3(b) and 3(c) show an undesired equipment table indicating equipment that customers do not desire and a desired equipment table indicating equipment that customers desire, respectively, both of which are associated with “equipment in March” shown in FIG. 3(a). Data shown in the desired and undesired equipment tables is generated based on answers to questionnaires collected in March. The undesired equipment table stores four worst specification items for each grade of the vehicle Y. The desired equipment table stores four best specification items for each grade of the vehicle Y.

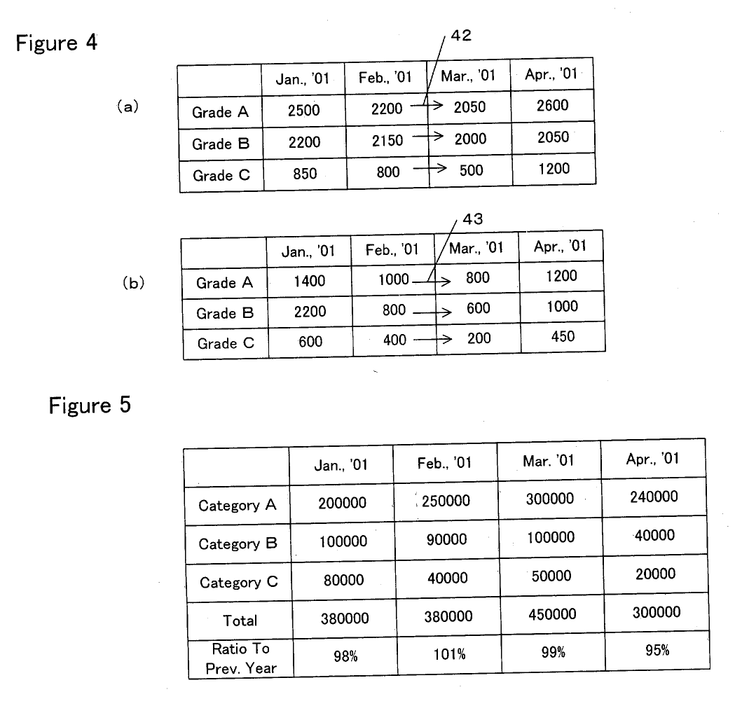

FIG. 4(a) shows an example of a sales volume table included in the sales database 11. Monthly sales volume for each grade of the vehicle Y is stored in the table. As indicated by an arrow 42, the sales volume for each of the grades A, B and C decreases over February through March.

FIG. 4(b) shows an example of an order volume table included in the sales database 11. Monthly order volume for each grade of the vehicle Y is stored in the table. As indicated by an arrow 43, the order volume for each of the grades A, B and C decreases over February through March. As described above, these decreases may be a trigger for activating the optimization process.

FIG. 5 shows an example of a table that stores monthly sales volume of vehicles belonging to each category in the vehicle industry. The table is included in the industry database 12. It is assumed that the vehicle Y belongs to the category “A”. It is seen that the sales volume of vehicles belonging to the category “A” in the vehicle industry increases over February through March. In contrast, the sales volume of the vehicle Y decreases, as shown in FIG. 4(a). The fact that the sales volume of the vehicle Y decreases despite the increase in the sales volume in the industry may be a trigger for activating the optimization process. Even if the industry sales volume decreases, the optimization process is activated when the decrease of the sales volume of the vehicle Y is larger than the decrease of the industry sales volume.

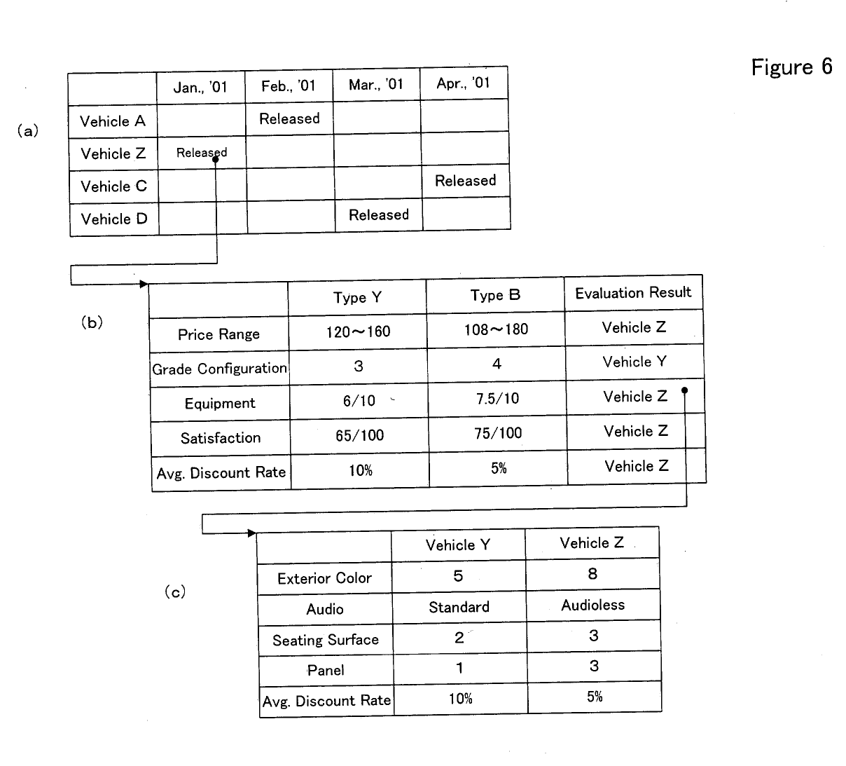

FIG. 6(a) shows an example of a table that includes new vehicles released by other companies. The table is included in the other-companies database 13. It is assumed that a vehicle Z of another company belongs to the same category as the vehicle Y. The vehicle Z has been released in January.

FIG. 6(b) shows an example of a table in which the vehicle Y and vehicle Z are compared. The table is associated with “vehicle Z in January” of FIG. 6(a). The comparison is performed for each of price range, grade configuration, equipment, customer satisfaction and average discount rate. It is evaluated that the vehicle Z is superior to the vehicle Y except for the grade configuration. The evaluation criteria are predetermined for each item. For example, as for the price range, it is evaluated that a vehicle having a lower price is superior.

FIG. 6(c) shows an example of a table including specification items that are associated with “evaluation result for the equipment” of FIG. 6(b). The specification items to be compared are predetermined. In the embodiment, the specification items compared for the equipment include exterior color, audio system, seating surface, panel. The table shows a difference between the vehicle Y and the vehicle Z for each specification item.

Alternatively, the tables of FIGS. 6(b) and 6(c) may include the result of a comparison of each grade of the vehicle Y with a given grade of the vehicle Z.

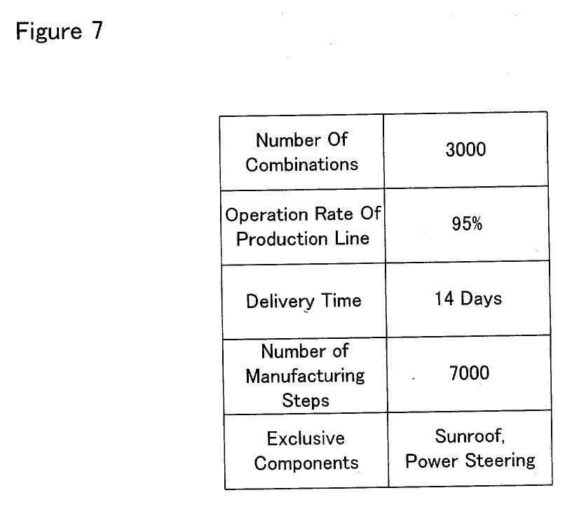

FIG. 7 shows an example of a table that includes the company requirements predefined for the vehicle Y. The table is included in the company requirement database 14. According to the table, under the condition in which the rate of operation of production lines is 95% and the delivery time is 14 days, the upper limit of the number of combinations of the specification items for the vehicle Y is 3000 and the upper limit of the number of manufacturing steps is 7000. As shown in the table, the sunroof and the power steering constitute one set of exclusive components.

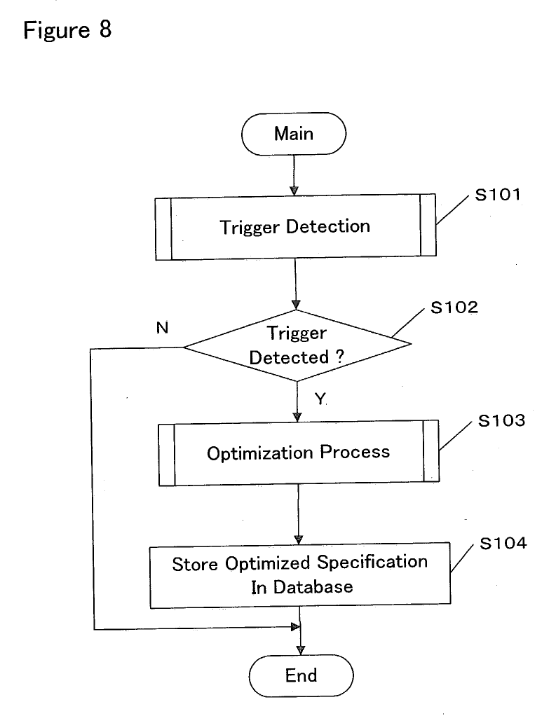

FIG. 8 shows a main routine of a process performed by the specification optimizing engine 30. The main routine is performed in predetermined time intervals (for example, once a month). The main routine is preferably performed after data about the customer satisfaction, sales volume and order volume has been stored in the databases 10 through 13 in each month.

In step S101, a trigger detection routine is performed to detect a trigger for activating the optimization process. If the trigger is detected (S102), the optimization process is performed (S103). If the trigger is not detected, the process exits the routine. In step S104, a specification generated by the optimization process is stored in the optimized specification database 25.

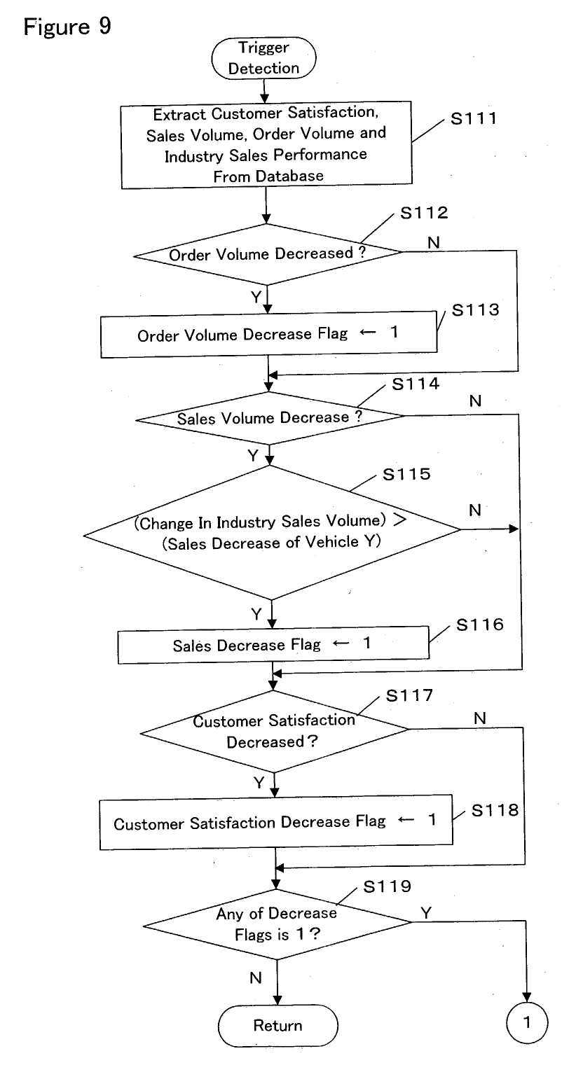

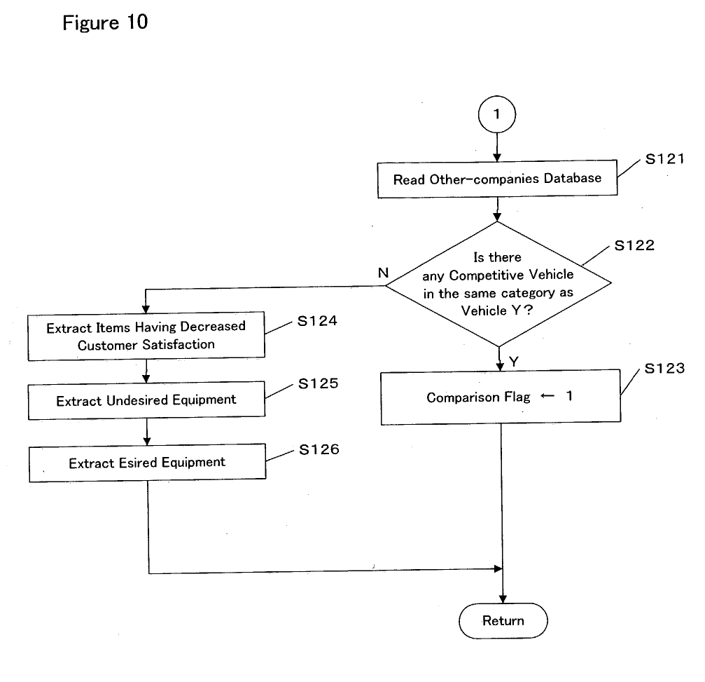

FIGS. 9 and 10 show a flowchart of a process, which is performed in step 101 of FIG. 8, for detecting the trigger to activate the optimization process.

In step S111, data of the current and previous months regarding the customer satisfaction, sales volume, order volume and industry sales performance are extracted from the customer satisfaction, sales, and industry databases 10 through 12. In step S112, it is determined whether the order volume of the current month has decreased from the previous month. If so, an order volume decrease flag is set to 1 (S113).

In step S114, it is determined whether the sales volume of the current month has decreased from the previous month. If so, a change in the industry sales volume for the category to which the vehicle Y belongs is compared with the decrease of the sales volume of the vehicle Y (S115). Here, the change in the industry sales volume is represented by a positive number (for example, +200) when the sales volume has increased, and is represented by a negative number (for example, −200) when the industry sales volume has decreased. The decrease in the sales volume of the vehicle Y is represented by a negative number.

If “the decrease in the sales volume of the vehicle Y”<“the change in the industry sales volume”, it indicates that the sales of the vehicle Y are more sluggish than the sales performance in the vehicle industry. A sales decrease flag is set to 1 (S116). If “the decrease in the sales volume of the vehicle Y”≧“the change in the industry sales volume”, it indicates that the decrease in the sales volume of the vehicle Y follows the sales performance in the vehicle industry. The sales decrease flag is not set because it is not determined that the sales decrease of the vehicle Y is caused by the specification of the vehicle Y.

In step S117, it is determined whether the score (customer satisfaction) of the current month has decreased from the previous month. If so, a satisfaction decrease flag is set to 1 (S118). In step 119, if one or more of the order volume decrease flag, the sales volume decrease flag and the satisfaction decrease flag is 1, the process proceeds to step S121 (FIG. 10). If all the decrease flags are zero, it indicates that the sales of the vehicle Y are going well. The process exits the routine because there is no need to change the specification.

In step S121 of FIG. 10, the other-companies database 13 is accessed. In step S122, it is determined whether a vehicle belonging to the same category as the vehicle Y has been released by another company within a predetermined time period (for example, in the past year). If such a vehicle Z has been released by another company, a comparison flag is set to 1 (S123) so as to perform the comparison between the vehicle Y and the vehicle Z. The process exits the routine. Alternatively, the comparison flag may be set to 1 if a sales volume of the vehicle Z is larger than the sales volume of the vehicle Y.

If the determination in step S122 is NO, items having the decreased score in the customer satisfaction table are extracted (S124). In the example shown in FIG. 3, the equipment, the price and the grade configuration are extracted as items having the decreased score.

The undesired equipment and the desired equipment for each of the items extracted in step S124 are extracted (S125 and S126). According to the example shown in FIG. 3, the undesired equipment and the desired equipment associated with the “equipment” item as shown in FIGS. 3(b) and 3(c) are extracted.

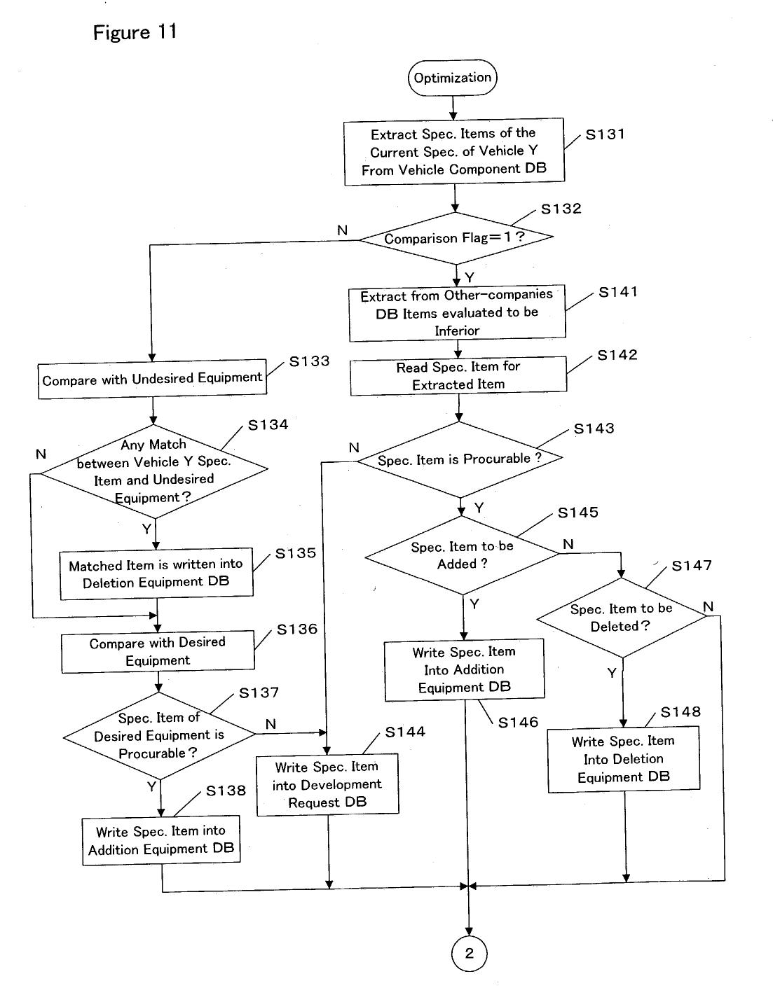

FIGS. 11 through 14 show a flowchart of the optimization process performed in step S103 of FIG. 8. In step S131, specification items included in the current specification of the vehicle Y are extracted from the vehicle component database 16.

In step S132, it is determined whether the value of the comparison flag is 1. If the value of the comparison flag is 1, it indicates that a vehicle belonging to the same category as the vehicle Y has been released by another company within the predetermined period. The process proceeds to step S141 so as to perform the above-described first optimization process. If the value of the comparison flag is not 1, it indicates that no vehicle belonging to the same category as the vehicle Y has been released by any other company within the predetermined period. The process proceeds to step S133 so as to perform the above-described second optimization process.

In step S133, the specification items of the vehicle Y extracted in step S131 are compared with specification items of the undesired equipment determined in step S125 (for example, aluminum wheel, cassette stereo, etc. for grade “A” in the example in FIG. 3(c)). If there is a match between the extracted specification items and the specification items of the undesired equipment, the matched specification item is written into the deletion equipment database 21. If there is no match, the process proceeds to step S136.

In step S136, for each of specification items of the desired equipment determined in step S126, it is determined whether the specification item is included in the procurable component database 17. If the specification item is procurable, it is written into the addition equipment database 20 (S138). If the specification item is not procurable, it is written into the development request database 22 (S144).

Thus, specification items to be added to and to be deleted from the current specification of the vehicle Y are extracted in accordance with the equipment that customers desire and the equipment that customers do not desire.

Returning to step S132, when the value of the comparison flag is 1, items for the vehicle Y that are evaluated to be inferior to the vehicle Z are extracted from the other-companies database 13 (S141). In the example of the table in FIG. 6(b), the items of price range, equipment, satisfaction and average discount rate are extracted.

In step 142, detailed data of the extracted items is extracted. In the example of the table in FIG. 6(c), for the extracted “equipment” item, specification items of exterior color, audio system, etc. are extracted.

In step S143, it is determined whether each of the extracted specification items is procurable. If the specification item is included in the procurable component database 17, it is determined that the specification item is procurable. If the specification item is not included in the procurable component database 17, it is determined that the specification item is not procurable. When the specification item determined to be not procurable, the specification item needs to be newly developed. The specification item is written into the development request database 22 (S144).

If the specification item is determined to be procurable, it is determined whether the specification item is included in the current specification items of the vehicle Y extracted in step S131. If not, the specification item is determined to be added (S145). If so, the specification item is determined to be deleted (S147).

If the specification item is determined to be added, the specification item is written into the addition equipment database 20 (S146). If the specification item is determined to be deleted, the specification item is written into the deletion equipment database 27 (S148). Thus, specification items determined to be added and to be deleted are extracted so as to make the specification of the vehicle Y comparable to the specification of the vehicle Z of the other company.

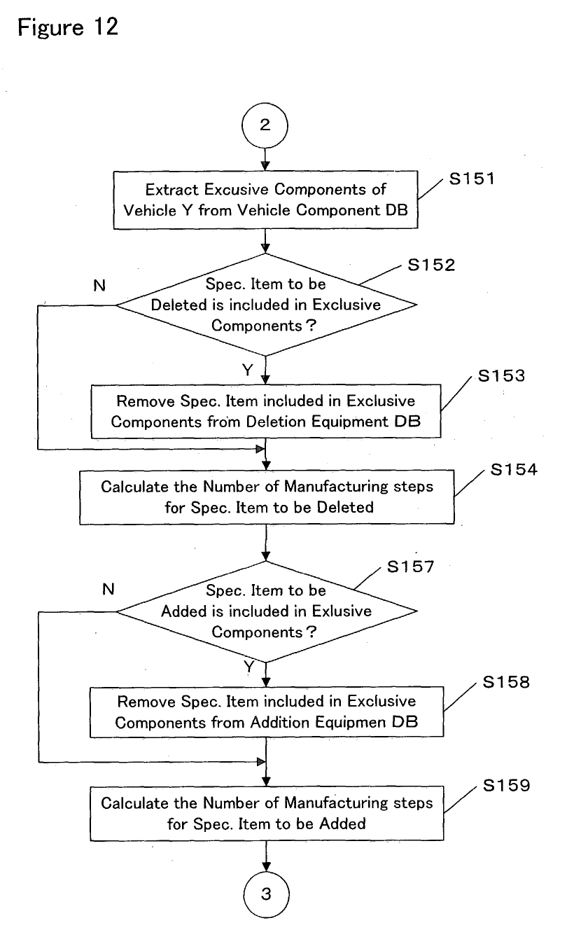

The process proceeds to step S151 of FIG. 12, in which exclusive components of the vehicle Y are extracted from the company requirement database 14. It is determined whether each of the specification items written in the deletion equipment database 21 is included in the exclusive components (S152). If so, the specification item is removed from the deletion equipment database 21 (S153). This is because it is not possible to remove only a component corresponding to the specification item from the vehicle Y. The component needs to be removed together with the other component(s) included in the set of exclusive components. Next, the number of manufacturing steps is calculated for each of the specification items determined to be deleted (S154).

In step S157, it is determined whether each of the specification items written in the addition equipment database 20 is included in the exclusive components. If so, the specification item is removed from the addition equipment database 20 (S158). This is because it is not possible to mount only a component corresponding to the specification item on the vehicle Y. The component needs to be mounted together with the other component(s) included in the set of exclusive components. Next, the number of manufacturing steps is calculated for each of the specification items determined to be added (S159).

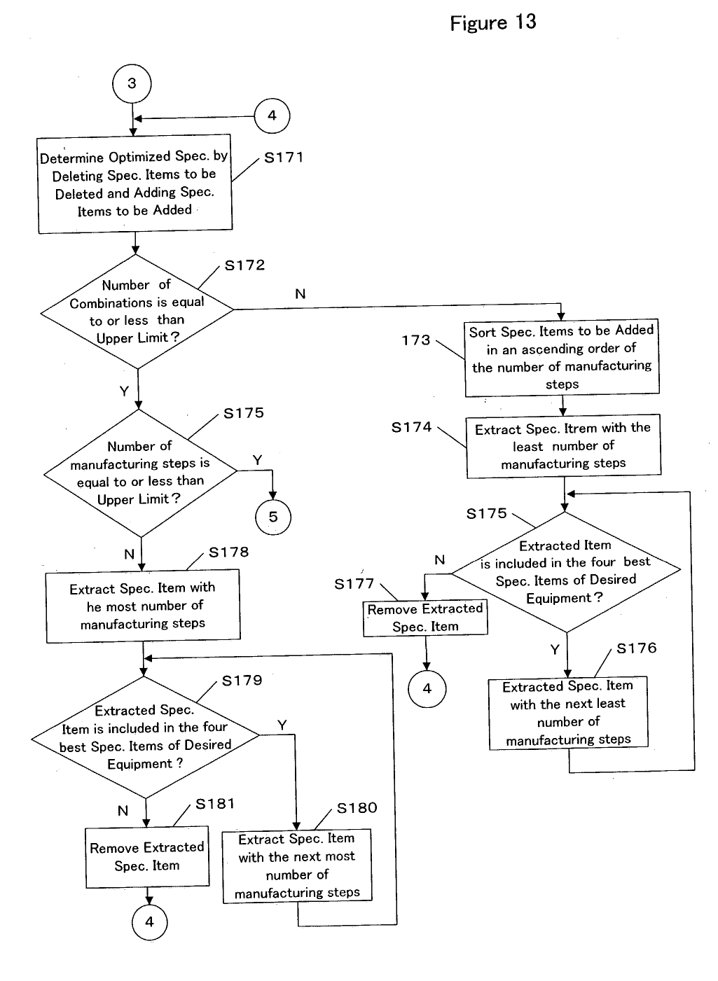

The process proceeds to step S171 of FIG. 13, in which the specification items stored in the addition equipment database 20 are added to the current specification of the vehicle Y. The specification items stored in the deletion equipment database 21 are deleted from the current specification of the vehicle Y. Thus, the optimized specification is determined. The number of manufacturing steps for all of the specification items determined to be added, which are calculated in step S154, are added to the number of manufacturing steps of the current specification. The number of manufacturing steps for all of the specification items determined to be deleted, which are calculated in step S159, are subtracted from the number of manufacturing steps of the current specification. Thus, the number of manufacturing steps of the optimized specification is determined.

Furthermore, in step S171, the number of combinations of the specification items of the optimized specification is determined. The number of combinations may be easily calculated based on the number of specification items. By way of example, it is assumed that there are three kinds of body colors (three specification items) and two kinds of panels (two specification items). If one kind of a panel is added (that is, the specification items increase from 2 to 3), the number of combinations increases from 6 to 9. However, calculation of the number of combinations typically involves various requirements. For example, there may exist a requirement that a particular panel is not mounted when the body color of the vehicle is a particular color. The number of combinations is calculated considering such a requirement.

In step S172, it is determined whether the number of combinations of the optimized specification is equal to or less than an upper limit (3000 in the example of the table in FIG. 7) of the number of combinations that is predefined in the company requirement database 14. If the number of combinations of the optimized specification exceeds the upper limit of the company requirement, it indicates that the current production line cannot accept the number of combinations of the optimized specification. Some of the specification items determined to be added need to be removed. In step S173, the specification items determined to be added, which are stored in the addition equipment database 20, are sorted in an ascending order of the number of manufacturing steps. A specification item with the least number of manufacturing steps is extracted (S174). If the extracted specification item is included in the four best specification items of the desired equipment (see FIG. 3(c)) in step S175, the extracted specification should not be removed. Therefore, the specification item with the next least number of manufacturing steps is extracted (S176).

Thus, steps 175 and 176 are repeated until a specification item that is not included in the desired equipment is selected. When the extracted specification item is not included in the desired equipment in step S175, the extracted specification item is removed from the addition equipment database 20 (S177).

Returning to step S171, the optimized specification is newly generated based on the specification items determined to be added and to be deleted which are included in the addition equipment database 20 and the deletion equipment database 21, respectively. If it is determined in step S172 that the number of combinations of the specification items of the generated optimized specification still exceeds the upper limit, steps S173 through S177 are performed again, so that a specification item with less number of manufacturing steps is removed from the addition equipment database 20. Because the specification item having less number of manufacturing steps is selected, the specification that meets the requirement for the number of combinations can be generated with less influence on the number of manufacturing steps.

When the number of combinations for the optimized specification is equal to or less than the upper limit in step S172, the process proceeds to step S175. In step S175, it is determined whether the number of manufacturing steps of the optimized specification is equal to or less than an upper limit of the number of manufacturing steps (7000 in the example of the table in FIG. 7) predefined in the company requirement database 14. If the number of manufacturing steps of the optimized specification exceeds the upper limit of the company requirement, at least one of the specification items determined to be added needs to be removed. In step S178, a specification item with the most number of manufacturing steps is extracted. If the extracted specification item is included in the four best specification items of the desired equipment in step S179, the extracted specification item should not be removed. Therefore, a specification item with the next most number of manufacturing steps is extracted in step S180.

The steps 179 and 180 are repeated until a specification item which is not included in the desired equipment is selected. If the extracted specification item is not included in the desired equipment in step S179, the extracted specification item is removed from the addition equipment database 20 (S181). The process proceeds to step S171, in which the optimized specification is newly generated based on the specification items determined to be added and to be deleted which are included in the addition equipment database 20 and the deletion equipment database 21, respectively. If the number of manufacturing steps of the generated optimized specification still exceeds the upper limit, steps S178 through S181 are performed again, so that a specification item with more number of manufacturing steps is removed. Since the specification item having more number of manufacturing steps is selected, the number of manufacturing steps of the specification can be surely adapted to the company requirement while the equipment that customers desire is maintained.

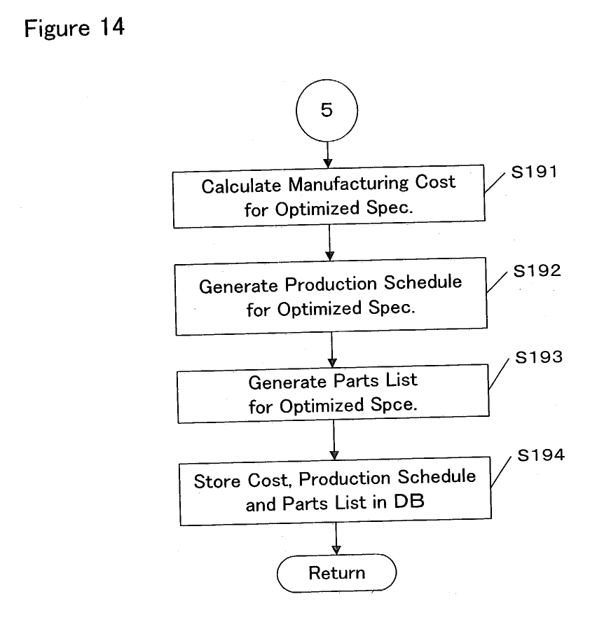

When the number of manufacturing steps of the optimized specification become equal to or less than the upper limit in step S175, the process proceeds to step S191 of FIG. 14.

In steps S191 through S193 of FIG. 14, the cost for the optimized specification is calculated. A production schedule and parts list are generated based on the optimized specification. Thus, vehicles based on the optimized specification that meet the company requirements can be manufactured. The calculated cost, generated production schedule and parts list are stored in a predetermined database (S194).

Although the present invention has been described above with respect to specific embodiments, the present invention is not limited to such embodiments.

What is claimed is:

1. A computer system for optimizing a vehicle specification that meets the needs of customers, comprising:
a customer database for storing one or more factors associated with the needs of customers for a vehicle; and
a specification optimizing engine programmed to:
analyze the factors in the customer database to determine whether the vehicle meets the needs of customers;
extract the needs of customers from the customer database if it is determined that the vehicle does not meet the needs of customers;
determine a vehicle specification optimized to meet the extracted needs of customers.

2. The computer system according to claim 1, wherein the specification optimizing engine is further programmed to adjust the optimized specification to meet the requirement of a vehicle supplier.

3. The computer system according to claim 1, wherein the factors include a score indicating the degree of customer satisfaction for the vehicle,
wherein the specification optimizing engine determines that the vehicle does not meet the needs of customers if the score decreases.

4. The computer system according to claim 1, wherein the factors include a sales volume of the vehicle or an order volume of the vehicle,
wherein the specification optimizing engine determines that the vehicle does not meet the needs of customers if the sales volume or the order volume for the vehicle decreases.

5. The computer system according to claim 1, wherein the factors include sales performance in the vehicle industry and a sales volume of the vehicle,
wherein the specification optimizing engine determines that the vehicle does not meet the needs of customers if the sales volume of the vehicle decreases compared with the sales performance in the vehicle industry.

6. The computer system according to claim 1, wherein the specification optimizing engine is further programmed to, in the determination of the optimized specification,
compare a current specification of the vehicle with a specification of a vehicle of another company;
extract a specification item of the current specification that is evaluated to be inferior to the specification of the vehicle of the other company;
modify the current specification for the extracted specification item so that the extracted specification item is comparable to the specification of the vehicle of the other company.

7. The computer system according to claim 1, wherein the needs of customers include a desired specification item that customers desire for a current specification of the vehicle and an undesired specification item that customers do not desire for the current specification of the vehicle;
wherein the specification optimizing engine is further programmed to, in the determination of the optimized specification:
add the desired specification item to the current specification of the vehicle;
delete the undesired specification item from the current specification of the vehicle.

8. The computer system according to claim 7, wherein the current specification of the vehicle includes a set of exclusive components, each component included in the set of exclusive components being neither added nor deleted independently,
wherein the specification optimizing engine is further programmed to:
cancel the addition of the desired specification item to the current specification if the desired specification item is included in the set of the exclusive components;
cancel the deletion of the undesired specification item from the current specification if the undesired specification item is included in the set of the exclusive components.

9. The computer system according to claim 2, wherein the company requirement includes an upper limit of the number of manufacturing steps for production of the vehicle;
wherein the specification optimizing engine is further programmed to adjust the optimized specification not to exceed the upper limit.

10. The computer system according to claim 2, wherein the company requirement includes an upper limit of the number of combinations of specification items included in a specification of the vehicle;
wherein the specification optimizing engine is further programmed to adjust the optimized specification not to exceed the upper limit.

11. A computer-implemented method for optimizing a vehicle specification to meet the needs of customers, comprising:
(a) extracting, from a customer database, one or more factors associated with the needs of customers for a vehicle;
(b) analyzing the extracted factors to determine whether the vehicle meets the needs of customers;
(c) extracting the needs of customers from the customer database if it is determined that the vehicle does not meet the needs of customers; and
(d) generating a vehicle specification optimized to meet the extracted needs of customers.

12. The method according to claim 11, further comprising:
(e) adjusting the optimized specification to meet the requirement of a vehicle supplier.

13. The method according to claim 11, wherein the factors include a score indicating the degree of customer satisfaction for the vehicle;
wherein the step (b) further includes determining that the vehicle does not meet the needs of customers if the score decreases.

14. The method according to claim 11, wherein the factors include a sales volume of the vehicle or an order volume of the vehicle;
wherein the step (b) further includes determining that the vehicle does not meet the needs of customers if the sales volume or the order volume of the vehicle decreases.

15. The method according to claim 11, wherein the factors include sales performance in the vehicle industry and a sales volume of the vehicle;
wherein the step (b) further includes determining that the vehicle does not meet the needs of customers if the sales volume of the vehicle decreases compared with the sales performance in the vehicle industry.

16. The method according to claim 11, wherein the step (d) further includes:
comparing a current specification of the vehicle with a specification of a vehicle of another company;
extracting a specification item of the current specification that is evaluated to be inferior to the specification of the vehicle of the other company; and
modifying the current specification for the extracted specification item so that the extracted specification item is comparable to the specification of the vehicle of the other company.

17. The method according to claim 11, wherein the needs of customers include a desired specification item that customers desire for a current specification of the vehicle and an undesired specification item that customers do not desire for the current specification of the vehicle;
wherein the step (d) further includes:
adding the desired specification item to the current specification of the vehicle;
deleting the undesired specification item from the current specification.

18. The method according to claim 17, wherein the current specification of the vehicle includes a set of exclusive components, each component of the set of the exclusive components being neither added nor deleted independently; and
wherein the step (d) further includes:
canceling the addition of the desired specification item to the current specification if the desired specification item is included in the set of the exclusive components;
canceling the deletion of the undesired specification item from the current specification if the undesired specification item is included in the set of the exclusive components.

19. The method according to claim 12, wherein the company requirement includes an upper limit of the number of manufacturing steps for production of the vehicle;
wherein the step (e) further includes adjusting the optimized specification not to exceed the upper limit.

20. The method according to claim 12, wherein the company requirement includes an upper limit of the number of combinations of specification items included in a specification of the vehicle;
wherein the step (e) further includes adjusting the optimized specification not to exceed the upper limit.
